(19) United States
(12) Patent Application Publication
(10) Pub. No.: US 2007/0171638 A1
(43) Pub. Date: Jul. 26, 2007

(54) Apparatus and methods for transmitting light over optical fibers

(75) Inventor: Donald L. Perry, Austin, TX (US)

Correspondence Address: PAUL S MADAN;MADAN, MOSSMAN & SRIRAM, PC, 2603 AUGUSTA, SUITE 700, HOUSTON, TX, 77057-1130, US

(73) Assignee: SBC Knowledge Ventures, L.P., Reno, NV (US)

(21) Appl. No.: 11/338,574

(22) Filed: Jan. 24, 2006

(51) Int. Cl. F21V 9/10

(52) U.S. Cl. 362/231; 362/554; 362/555

(57) ABSTRACT

An apparatus for providing a light of at least two colors to an optical fiber is disclosed. The apparatus includes a source for the at least two colors and a controller that controls the source to generate lights having selected duty cycles.

### BACKGROUND OF THE DISCLOSURE

1. Field of the Disclosure

The present disclosure relates to the field of optical equipment.

2. Description of the Related Art

Optical fibers are often manufactured of glass and are clad in reflective material, allowing for total (or nearly total) internal reflection of any light that is carried within the fiber. Light that is shone into one end of an optical fiber may be carried along the optical fiber substantially without loss, and may emerge from the other end of the optical fiber. The optical fiber may even be bent with an adequately large bend radius, without introducing significant loss. By flickering the light according to a code, the optical fiber may be made to carry almost any kind of data, including video, voice, and binary data.

Optical fibers, however, may break or become worn through use. As the cladding around an optical fiber begins to deteriorate, or if the optical fiber is bent too severely, or has a break, light may begin to escape, introducing a loss. It may become necessary to repair or replace the optical fiber to restore data integrity along the optical fiber.

In large fiberoptic networks, many optical fibers are bundled together and connected to nodes, which may serve as junctions. Several hundred optical fibers may connect one node to another, providing a very high bandwidth but making it difficult to determine which optical fiber has a problem. To determine which optical fiber has become defective, a technician may shine a light into one end of an optical fiber, and another technician at the other end of the optical fiber may attempt to detect the light. If the other technician can detect the light, then the optical fiber is not broken; otherwise the fiber is repaired, replaced or discarded.

A laser pointer or other light source is typically used to shine light at one end of the fiber. Laser pointers often have a steady red light, that can be switched on and off. Some laser points also have a mode in which the light automatically switches on and off periodically. A technician may shine a laser pointer into one end of each optical fiber in a bundle, and another technician may try to detect the light at the other end of each optical fiber, until the broken optical fiber is detected.

Sometimes, the light that is shone into one end of an optical fiber may be difficult to see at the other end. Ambient lighting conditions may be poor, or the other technician may have poor eyesight. A pulsating red light may be as difficult to see as a steady red light. Thus, there is a need for an improved apparatus and method for testing optical fiber.

### BRIEF DESCRIPTION OF THE DRAWINGS

For detailed understanding of the present disclosure, references should be made to the following detailed description of an exemplary embodiment, taken in conjunction with the accompanying drawings, in which like elements have been given like numerals, wherein:

FIG.1 is a functional diagram of an apparatus for providing a light over an optical fiber, in accordance with an embodiment of the present disclosure;

FIG.2 is a diagram of a device that includes the apparatus of FIG. 1;

FIG. 3 is a diagram of a system in accordance with an embodiment of the present disclosure;

FIG. 4 is a diagram of a system in accordance with another embodiment of the present disclosure; and

FIG. 5 is a flowchart of an exemplary method in accordance with an embodiment of the present disclosure.

### DETAILED DESCRIPTION OF THE DISCLOSURE

In view of the above, the present disclosure through one or more of its various aspects and/or embodiments is presented to provide one or more advantages, such as those noted below.

The present disclosure in one aspect provides an apparatus for transmitting light over an optical fiber. The apparatus in one aspect includes a source of at least two colors of light and a controller that controls the source to generate the at least two colors of light with a selected duty cycle. In one aspect, the source may include a light-emitting diode (LED) for providing a color of light. In another aspect, the source may include a laser for providing a color of light. The colors of light may be in the visible spectrum and may include red, green, black, yellow, blue and orange colors. The apparatus, in another aspect, includes a timing mechanism operative to control intensity of at least one color of light. The controller may control the duty cycle by switching among different lights. A single source may be utilized to produce multiple colors of light.

In another aspect, a method of transmitting light through optical fibers is provided. The method may include selecting at least two colors of light; selecting an optical fiber from among a group of optical fibers that extends from a first location to a second location; and transmitting the at least two colors of light via the optical fiber, each color of light having a selected duty cycle. The method, in another aspect, utilizes LEDs or lasers as the source for the various colors of light, which may include, red, green, yellow, orange and black lights. In another aspect, the duty cycle may be controlled and may be different for different colors of light. A fluorescence member placed at the second end may be used to detect the transmission of light through the fiber and the integrity of the fiber. Additionally, intensity of any of the colors may be changed during transmission.

The present disclosure, in another aspect, provides a system for providing a light over an optical fiber that includes a source of at least two colors of light, a controller for controlling the source and a connector operative to couple the system to provide the at least two colors of light to a first end of the optical fiber, the optical fiber being of a group of optical fibers that extends from the first location to a second location. The source may include LEDs or lasers. The controller controls the duty cycle and intensity of the colors of light. A single source may be utilized to generate multiple colors of light.

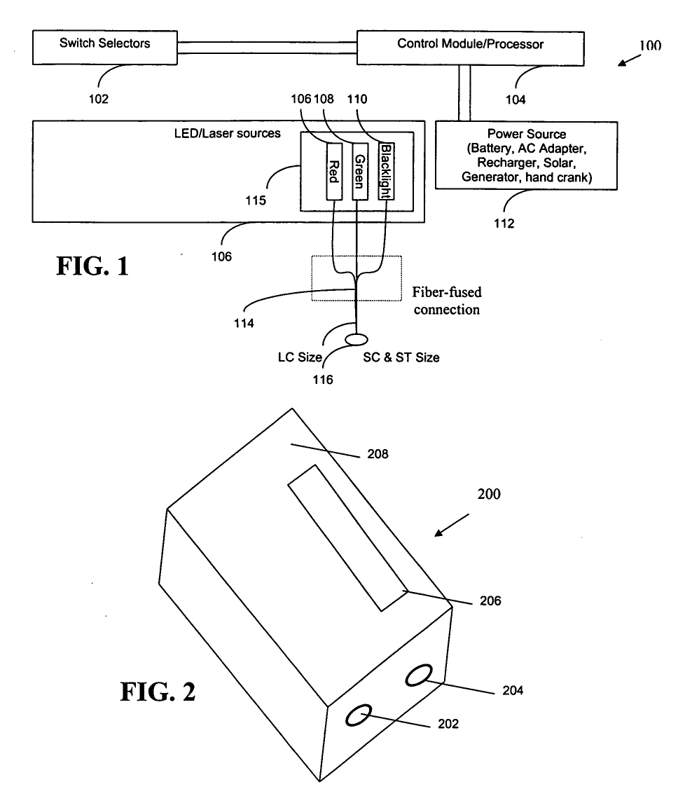

FIG.1 is a functional diagram of an apparatus 100 for providing a light over an optical fiber, in accordance with an embodiment of the present disclosure. The apparatus 100 includes a source of at least two colors of light; that may include a red light 106, a green light 108, and a black light 110. It will be appreciated that other colors may be used instead of, or in addition to, any or all of these colors of light.

The apparatus 100 also includes a selector, such as a switch selector 102, that can control the source of at least two colors of light. The switch selector 102 may include several switches, knobs, or other controls that a technician may manipulate to control the light emitted by the apparatus 100. For example, the switch selector 102 may include a frequency control (or a period control) and a start-delay control for each of the red light 106, the green light 108, and the black light 110. The switch selector 102 may also have an intensity control for each of the red light 106, the green light 108, and the black light 110. Also, the switch selector 102 may have a flash memory or other memory that stores preferences.

The apparatus 100 also includes a control module/processor (also referred to as a controller) 104 that can toggle (switch), increase, or decrease power to each of the lights, according to the switch selector 102. The control module processor 104 may also include a timing mechanism that can control the toggling (or switching ), increasing, or decreasing of the power (i.e., the intensity) of at least one color of light. The control module processor 104 may be, or may include, a microprocessor, or may be implemented as an analog circuit, a digital circuit, and/or a hybrid circuit.

The apparatus 100 may be configured to toggle the lights in any desired manner. For example, the apparatus 100 may configure to toggle the red light 106 and the green light 108 with a 50% duty cycle, each light coming on when the other light is off. In another situation, each light may be used with a ⅓ duty cycle, such that all three lights are switched on and off in turn.

Other patterns are also contemplated by the present disclsoure. For example, any one or more of the lights may be programmed to flash, pulse, vary in intensity, vary in timing, vary in frequency, or vary in delay during any particular duty cycle. For example the red light 106 may be programmed to shine with a first intensity for ⅓ of a second, then increase in intensity to a higher power level for ⅕ of a second, and then flash briefly and brightly at a third intensity. The green light 108 may be programmed to behave similarly at a greater delay than the red light 106.

The control module processor 104 may be used to phase (that is, ramp up the intensity) or pulse (that is, toggle the intensity between a high level and off), or may allow the light to remain on continuously. If desired, a blue light (not shown) may also be added to provide a full complement of red, green, and blue, and a yellow light (not shown) may also be added. The red light 106 may produce light of approximately 635 nm wavelength, the green light 108 may produce light of approximately 532 nm wavelength, the yellow light (not shown) may produce light of approximately 594 nm wavelength, the blue light (not shown) may produce light of approximately 473 nm wavelength, and the black light 110 may produce light of approximately 420 nm wavelength, each at a suitable power, such as 5 mW.

It should be appreciated that the lights need not be illuminated individually; several lights may be illuminated simultaneously. An intensity of the red light 106 may be represented as an “R” value, and an intensity of the green light 108 may be represented as a “G” value. If a blue light is added, then an intensity of the blue light may be represented as a “B” value. Since many colors may be provided simultaneously, an RGB color scheme may be implemented that can allow almost any specific color desired to be achieved.

The black light 110 may also be implemented, allowing an additional ultraviolet energy to be added to the illumination. Similarly, an infrared light may also be added to achieve a low-frequency extension to the visible spectrum.

The apparatus may also include connections, such as a fiber-fused connection 114. For example, a spectrally diverse holographic refraction grating or prism may be used to combine the colors of light into a single path. Just as a prism can be used to spatially separate each of the colors in white light into a separate light path, a prism may also be used (in the opposite direction) to combine the colors of separate light paths into a single ray of light. Accordingly, the fiber-fused connection 114 may be used to combine the colors of light (including the black light 110) into a single ray of light. The ray of light may be provided, across an internal optical fiber, to a portable connector 116.

The apparatus also includes a power source 112 that may include, for example, a battery, an AC adapter, a battery recharger, a solar-powered voltage supply, an electrical generator, and/or a hand crank. Other sources of power are also contemplated. For example, an external light source may be provided, and apparatus may be used to filter or focus the light into the portable connector 116. It will be obvious that a single light source 115 may be utilized, instead of separate sources 106, 108 and 110 that generates a single or multiple color of light. A switch without a control module may also be utilized to operate such a source.

FIG.2 is a diagram of a device 200 that includes the apparatus of FIG. 1. The device 200 has a first portable connector 202 and a second portable connector 204 that allow the device to be coupled to two different standard sizes of optical fibers such that, when the device is coupled to an optical fiber, the device can provide the colors of light to the optical fiber. If desired, the device may include only one portable connector.

The device 200 also has a readout 206 that allows a technician to see which colors are illuminated, and whether a particular light is phasing, pulsing, continuous, or combined. The particular light is identified, and the device 200 may indicate whether it is off.

When the device 200 is operating in a continuous mode, the colors of the light that are illuminated are also indicated in a continuous mode readout 208. Red, Green, Blue, and Black lights may be represented as a steady light, a flashing light, or a numerical value. If other modes are used, such as flashing or pulsing, then the device may also indicate, in addition to maximum intensity: frequency, rampup time, rampdown time, and a delay within each duty cycle that the rampup or rampdown is to begin.

If desired, the continuous mode readout 208 may simply be replaced with openings or holes that allow some of the light generated within the device 200 to emerge. When light within the visible spectrum is used, the light may be seen through the holes. Similarly, the holes may be colored with transparent or translucent material that can allow a technician using the device to see the light within the device.

Similarly, a phosphorescent covering may be used, which may phosphoresce when a black light is produced within the device, or an internal surface of the device that can be seen through the holes can be covered with a florescent paint. Accordingly, the technician may be able to see that black light is being generated within the device. Alternatively, or additionally, the control module processor 104 may be wired to indicators within the readout to inform the technician that light is being generated.

Internal to the device, the apparatus may include at least two light-emitting diodes (LEDs) or lasers each optically coupled to provide, when on, a color of light to the portable connector. The colors include a red light, a green light, a black light, a blue light, and/or a yellow light.

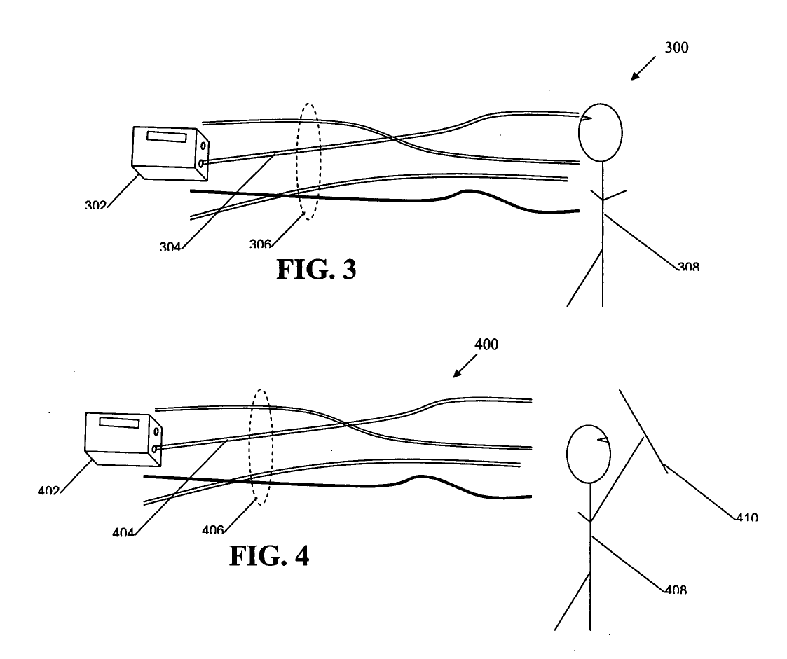

FIG. 3 is a diagram of a system 300 in accordance with an embodiment of the present disclosure. The system 300 may be used for providing a light over an optical fiber. The light may be generated within a device 302, located at a first location, which can be a source of one or more colors of light. The device 302 includes a selector that can be used to control the source one or more colors of light, and also includes a portable connector that can be used to couple the device 302 to an optical fiber 304, such that a substantial portion of the light produced within the device 302 is provided over the optical fiber 304. The device 302 is coupled to provide the colors of light to a first end of the optical fiber 304.

The device 302 may include at least two light-emitting diodes (LEDs) or lasers each optically coupled to provide, when on, a color of light to the portable connector. The colors of light may include, for example, at least two of: a red light, a green light, and a black light, such that the colors may be visible at the remote location, and such that the optical fiber may be identified from among the group of optical fibers. A blue light, a yellow light, an infrared light, and many other colors of light may be used in addition to, or instead of, any of the red light, green light, and black light. The device also includes a fiber-fused connection that allows all of the colors of light that are produced within the device to be combined and provided via the connector to the optical fiber 304. The device 302 also includes a timing mechanism that can control and toggle an intensity of at least one color of light, and a readout to allow the technician at the first location to determine and control which colors of light are being produced, and which pattern of frequency, period, intensity and delay is desired.

FIG. 3 also shows a group 306 of optical fibers, including the optical fiber 304, that extend from the first location to a remote location. Accordingly, the optical fiber 304 is one of many optical fibers that extend from the first location to a remote location. The first location and the remote location may be many miles apart, and may even be in different cities or countries, but are connected by many optical fibers.

A second technician 308, who is at the remote location, can examine each optical fiber to determine whether any of the group of optical fibers 306 is providing light. Eventually, the second technician 306 examines the optical fiber 304, and determines that the optical fiber 304 does not need repair, since visible light is emitting from the optical fiber 304. The second technician 308 may use a magnifying glass and/or a photovoltaic sensor responsive to any light to help discern the light.

If a non-visible frequency of light is used, such as black (i.e., ultraviolet) light, the second technician 308 may use a small pane of glass that has been coated with a phosphorescent material. Like a television set or other cathode ray tube, the small pane of glass fluoresce when illuminated with black light. If the second technician 308 determines that none of the group of optical fibers 306 is emitting light at the remote location, then the second technician 308 can send a message to the technician at the first location. The message can indicate that an optical fiber needing repair has been identified. The technician at the first location can identify which optical fiber needs repair, and can either perform the repair or order that the repair is done. The message may be communicated by other communication equipment, such as a radio or cellular telephone, or may be sent via an optical fiber that has been determined to be functioning properly. Any optical fiber of the group 306 of optical fibers may be used to send the message.

FIG. 4 is a diagram of a system 400 in accordance with another embodiment of the present disclosure. The system may be used for providing black light, also known as ultraviolet light, over an optical fiber 404. The black light may be generated within a device 402, located at a first location. The black light need not be the only color of light produced at the first location and provided over the optical fiber 404. The device 402 includes a selector that can be used to control the source one or more colors of light.

The black light may be produced by a light-emitting diode (LEDs) or laser that is coupled to provide, when on, the black light. Other colors of light may also be added to the black light. The other colors of light may include, for example, at least two of: a red light, a green light, and a black light, such that the colors may be visible at the remote location, and such that the optical fiber may be identified from among the group of optical fibers, some of which may be in the visible spectrum. A blue light, a yellow light, an infrared light, and many other colors of light may be used in addition to the black light. The device 402 may include a fiber-fused connection that allows all of the colors of light that are produced within the device to be combined and provided via the connector to the optical fiber 404. The device 402 also includes a timing mechanism that can control and toggle an intensity of at least one color of light, and a readout to allow the technician at the first location to determine and control which colors of light are being produced, and which pattern of frequency, period, intensity and delay is desired.

FIG. 4 also shows a group 406 of optical fibers, including the optical fiber 404, that extend from the first location to a remote location. Accordingly, the optical fiber 404 is one of many optical fibers that extend from the first location to a remote location. The first location and the remote location may be many miles apart, and may even be in different cities or countries, but are connected by many optical fibers.

A second technician 408, who is at the remote location, can examine each optical fiber to determine whether any of the group of optical fibers 406 is providing light. To examine each optical fiber, the second technician 408 may use an object 410 that is covered with a fluorescent material. The object 410 may be a card, a pen, or a piece of equipment, and fluoresces when exposed to the black light. The second technician 408 may use a magnifying glass and/or a photovoltaic sensor responsive to any light to help discern the light. Like a television set or other cathode ray tube, the small pane of glass may fluoresce when illuminated with black light. Eventually, the second technician 406 examines the optical fiber 404, and determines that the optical fiber 404 does not need repair, since light is visible emitting from the optical fiber 404.

If the second technician 408 determines that none of the group of optical fibers 406 is emitting light at the remote location, then the second technician 408 can send a message to the technician at the first location. The message can indicate that an optical fiber needing repair has been identified. The technician at the first location can identify which optical fiber needs repair, and can either perform the repair or order that the repair be done. The message may be communicated by other communication equipment, such as a radio or cellular telephone, or may be sent via an optical fiber that has been determined to be functioning properly. Any optical fiber of the group 406 of optical fibers may be used to send the message.

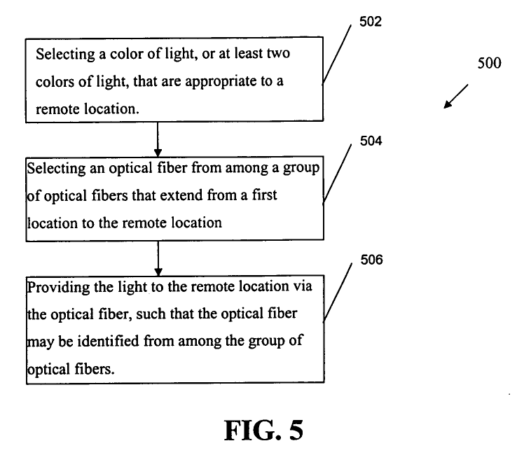

FIG. 5 is a flowchart of an exemplary method in accordance with an embodiment of the present disclosure. The method includes transmitting 502 a color of light, or at least two colors of light, that are appropriate to a remote location. A technician, for example, may determine that an ambient lighting condition at remote location includes so much red light that a red light emitted from an optical fiber may not be seen, or the technician may determine that a second technician is colorblind or has another ocular medical condition that prevents the second technician from seeing a particular color of light. Accordingly, the technician may select a color of light that the second technician is cable of seeing or detecting. For example, the technician may decide that a bright flashing green light combined with a strong steady black light would be most appropriate.

The method also includes selecting 504 an optical fiber from among a group of optical fibers that extend from a first location to the remote location. The optical fiber may be one that is suspected of possibly having become broken or deteriorated. The group of optical fibers may be available in a patch board or other optical junction. The first location may be under a manhole, in an electrical cabinet, or on a telephone pole, but allows the technician to access the optical fiber.

The method also includes providing 506 the light to the remote location via the optical fiber, such that the optical fiber may be identified from among the group of optical fibers. For example, the light may be provided from at least two light-emitting diodes (LEDs) or lasers, each optically coupled to provide a color of light when on. The light may be toggled among several colors of light. The light may include a red light, a green light, a black light, a blue light, a yellow light, an infrared light, and/or other colors of light.

It will be understood that the foregoing description is merely an example of the disclosure, which is not limited by such description, but rather by the claims and their equivalents. The scope of the disclosure herein also includes any novel feature or any novel combination of features disclosed either explicitly or implicitly or any generalization or modification thereof which would be apparent to persons skilled in the relevant art, and any and all legal equivalents thereof, whether or not such relates to the same disclosure as presently claimed in any claim and whether or not it mitigates any or all of the same technical problems as confronted by the present disclosure. The teachings of the foregoing disclosure will suggest other modifications to those persons skilled in the relevant art, including some modifications that may involve other features which are already known and which may be used instead of or in addition to features already described herein. The applicants hereby reserve the right to formulate new claims to such features and/or combinations of such features during the prosecution of the present application or of any further application derived there from.

What is claimed is:

1. An apparatus for transmitting light over an optical fiber, the apparatus comprising:
a source of at least two colors of light; and
a controller that controls the source of at least two colors of light to generate the at least two colors of light with a selected duty cycle.

2. The apparatus of claim 1, wherein:
the source includes a light-emitting diode (LED) for providing a color of light.

3. The apparatus of claim 1, wherein:
the source includes a laser for providing a color of light.

4. The apparatus of claim 1, wherein:
the colors include at least two of: red, green, black, yellow, blue and orange.

5. The apparatus of claim 1, wherein:
one of the colors is black.

6. The apparatus of claim 1, further comprising:
a timing mechanism operative to control intensity of at least one color of light.

7. The apparatus of claim 6, wherein:
the timing mechanism and a selector are operative to cooperatively switch among the at least two colors of light.

8. A method for providing a light over an optical fiber, the method comprising:
selecting at least two colors of light;
selecting an optical fiber from among a group of optical fibers that extend from a first location to a second location; and
transmitting the at least two colors of light via the selected optical fiber, each color of light having a selected duty cycle.

9. The method of claim 8, wherein:
transmitting the at least two colors of light further includes switching among at least two light-emitting diodes (LEDs).

10. The method of claim 8, wherein:
transmitting the at least two colors of light further includes switching among at least two lasers.

11. The method of claim 8, wherein: transmitting the at least two colors includes providing at least two of red, green, yellow, orange and black lights.

12. The method of claim 8 further comprising, detecting emission of at least one of the at least two colors of light at the second location to determine a fault in the optical fiber.

13. The method of claim 8, wherein the duty cycle differs between at least two light colors

14. The method of claim 13, further comprising changing intensity of at least one color of light.

15. A system for providing a light over an optical fiber, the system comprising:
a source of at least two colors of light;
a controller operative to control the source; and
a connector operative to couple the system to provide the at least two colors of light to a first end of the optical fiber, the optical fiber being of a group of optical fibers that extends from a first location to a second location.

16. The system of claim 15, wherein:
the source includes at least two light-emitting diodes (LEDs), each optically coupled to provide a color of light to the connector.

17. The system of claim 15, wherein:
the source includes at least two lasers, each optically coupled to provide a color of light to the connector.

18. The system of claim 15, wherein each of the at least two colors of light has a selected duty cycle.

19. The system of claim 15, wherein at least one of the at least two colors of light is black that fluoresces at a second end of the optical fiber.

20. The system of claim 15, further comprising:
a timing mechanism operative to control intensity of at least one color of light.
